(19) United States
(12) Patent Application Publication
(10) Pub. No.: US 2002/0109782 A1
(43) Pub. Date: Aug. 15, 2002

(54) Information processing apparatus

(75) Inventors: Satoshi Ejima, Tokyo (JP); Akira Ohmura, Kawasaki-shi (JP)

Correspondence Address: OLIFF & BERRIDGE, PLC, P.O. Box 19928, Alexandria, VA, 22320, US

(73) Assignee: Nikon Corporation

(21) Appl. No.: 10/060,315

(22) Filed: Feb. 1, 2002

Related U.S. Application Data
(63) Continuation of application No. 08/972,678, filed on Nov. 18, 1997, now abandoned.
(60) Provisional application No. 60/041,718, filed on Mar. 27, 1997.

(30) Foreign Application Priority Data
Dec. 26, 1996 (JP) 08-347120
Apr. 22, 1997 (JP) 09-104169

(51) Int. Cl. H04N 5/222

(52) U.S. Cl. 348/333.01

(57) ABSTRACT

The invention provides improved operability for portable electronic devices. An electronic camera takes in an image with a predetermined cycle, detects rotation of the electronic camera around the X-axis and the Y-axis, for example, based upon the displacement of the image taken in, and scrolls the image displayed on the screen of a LCD or moves the cursor displayed on the screen of a LCD. Alternatively, the displayed image could have its magnification level changed. A number of different techniques and structures are provided to detect various movements of the electronic camera.

### RELATED PROVISIONAL APPLICATION

This nonprovisional application claims the benefit of Provisional Application No. 60/041,718 filed on Mar. 27, 1997.

### INCORPORATION BY REFERENCE

The disclosures of the following priority applications are herein incorporated by reference: Japanese Patent Application No. 08-347120, filed Dec. 26, 1996 and Japanese Patent Application No. 09-104169, filed Apr. 22 1997.

### BACKGROUND OF THE INVENTION

1. Field of Invention

The invention relates to information processing apparatus. In particular, it relates to information processing apparatus which process stored information to display an image which can be scrolled by moving or rotating the apparatus.

2. Description of Related Art

Conventionally, pointing devices, such as joy sticks or a mouse have been used to scroll an image displayed on a screen or to move a cursor. For example, an image, or even a cursor may be scrolled in a particular direction by moving the joy stick in that direction. Similarly, by moving a mouse in a particular direction, an image or a cursor displayed on a screen may be moved in a particular direction.

When scrolling an image displayed on the screen of a portable device or when moving a cursor on a menu screen, a joy stick, or other pointing device may be integrated with the portable device, however, this is not always desirable from an ease-of-use point of view.

### SUMMARY OF THE INVENTION

Considering the problem described above, it is an object of the invention to provide a system which enables easy manipulation of an image and a menu screen when displayed on the screen of a portable device.

According to one aspect of the invention, an information processing apparatus includes a display means for displaying at least one of images, characters and graphics; a detection means for detecting either rotation or linear movement of the display means; and a display changing means which changes the display shown by the display means depending on the rotation or movement of the display means as detected by the detection means.

The detection means also can photograph a series of predetermined images and detect the movement and rotation of the display means based on changes in the photographed image over time.

The detection means can include a CCD. The detection means can detect the rotation of the display means based on a detected angular velocity.

The detection means also can detect the angular velocity with respect to two axes and detect the bearings and the rotation of the display means based on the change in bearings detected over time. The detection means may include a piezoelectric gyroscope or an electronic compass.

The apparatus also can include a photo imaging means which photographs the image of a specified object; a storage means which stores the image photographed by the photo imaging means; and a control means which controls the photo-imaging of the object by the photo imaging means and stores the photographed image of the object photographed by the photo imaging means into the storage means. The display changing means also changes the contents displayed on the display means when the control means does not cause the photo imaging means to photograph the object and when it fails to process a photographed image for storage into the storage means.

The display changing means can either magnify or shrink the contents displayed on the display means when movement of the display means along the optical axis of the detection means is detected by the detection means.

Additionally, when either the movement and/or the rotation of the display means is detected by the detection means, a prevention means can prevent the display changing means from executing a process to change the contents displayed on the display means.

Also, when rotation around a specified straight line perpendicular to the screen of the display means is detected by the detection means, the display changing means can rotate the contents displayed on the display means by a specified angle. When rotation around a specified straight line parallel to the screen of the display means is detected by the detection means, the display change means is able to scroll the contents displayed on the display means in a specified direction.

A recording medium is also provided to control the information processing apparatus as detailed above.

### BRIEF DESCRIPTION OF THE DRAWINGS

The invention will be described in conjunction with the following drawings in which like reference numerals designate like elements and wherein:

FIG. 1 is a perspective view of the front of an electronic camera which is an information processing apparatus according to an embodiment of the invention;

FIG. 2 shows a perspective view of the back of the FIG. 1 apparatus;

FIG. 3 shows a perspective view of the FIG. 1 electronic camera with the LCD cover closed;

FIG. 4 shows a perspective view showing the inside of the FIG. 1 electronic camera;

FIGS. 5A-5C show various positional relationships between an arm member on the LCD cover and a LCD switch according to an embodiment of the invention;

FIG. 6 shows a block diagram of the internal electrical structure of the FIG. 1 electronic camera;

FIG. 7 shows the thinning process of the pixels during the L mode according to an embodiment of the invention;

FIG. 8 shows the thinning process of the pixels during the H mode according to an embodiment of the invention;

FIG. 9 shows an example of the display screen of the FIG. 1 electronic camera;

FIG. 10 shows the X-axis and Y-axis defined with respect to the electronic camera according to an embodiment of the invention;

FIG. 11 is a flow chart showing a process for detecting the movement and rotation of the electronic camera according to an embodiment of the invention;

FIGS. 12A and 12B show the relationship between an image and a display area as displayed in a LCD;

FIGS. 13A-C show a menu screen and a set-up choice selection screen;

FIG. 14 shows a block diagram of the internal electrical structure of the electronic camera according to an embodiment of the invention;

FIG. 15 is a flow chart showing a method of detecting the rotation of the electronic camera based on the angular velocity detected by a piezoelectric gyro according to an embodiment of the invention;

FIG. 16 shows a block diagram of the internal electrical structure of the electronic camera according to an embodiment of the invention;

FIG. 17 is a flow chart showing a method of detecting the rotation of the electronic camera based on the bearings detected by the electronic compass and the controlling of the screen display according to an embodiment of the invention;

FIG. 18 is a flow chart showing a process for controlling the screen display and detecting the movement or rotational movement of the electronic camera according to an embodiment of the invention;

FIG. 19 shows an operation in which the electronic camera is moved in a direction substantially parallel to the optical axis of a photographic lens;

FIG. 20 shows the time series change of the image obtained by the CCD when the operation shown in FIG. 19 is accomplished;

FIG. 21 shows the time series change of the image obtained by the CCD when the electronic camera is moved rotationally around the Z axis; and

FIG. 22 shows the relationship between an image and a display area as displayed in a LCD.

### DETAILED DESCRIPTION OF PREFERRED EMBODIMENTS

Embodiments of the invention are described with reference to the drawings as follows.

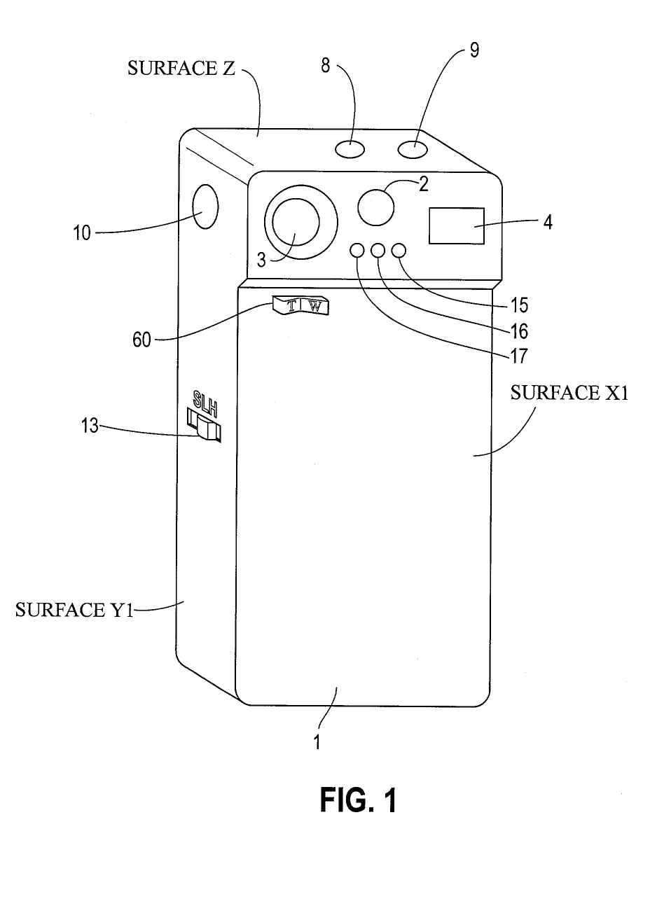

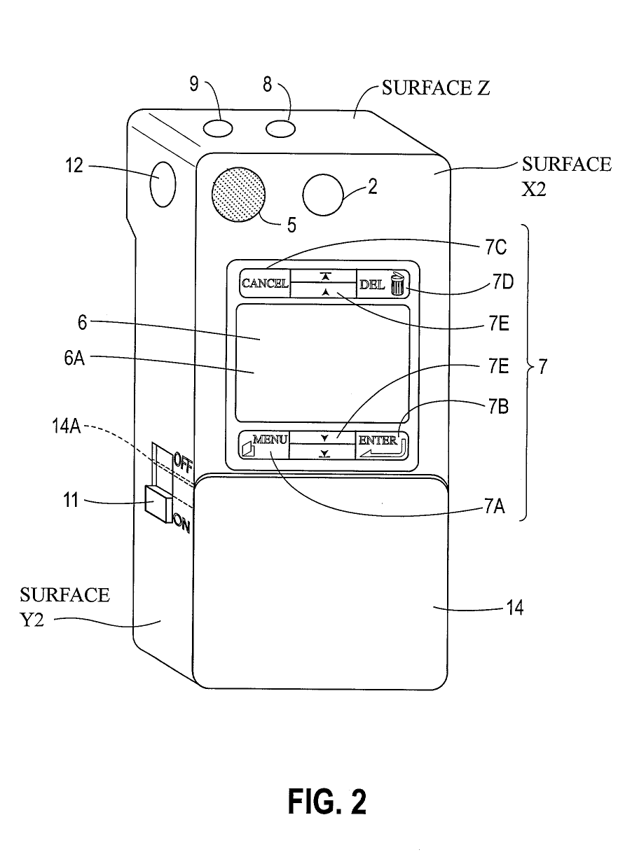

FIG. 1 and FIG. 2 are perspective views showing structural examples of an embodiment of an electronic camera according to the invention. In the electronic camera, the camera surface facing the object is defined as surface X1 and the surface facing the user when the object is photographed is defined as surface X2. A viewfinder 2 which is used to verify the shooting range of the object is located on the top edge section of the surface X1. A shooting lens 3, which takes in the optical image of the object, and a light emitting unit (strobe) 4, which emits light to illuminate the object, are also provided on the top edge section of the surface X1.

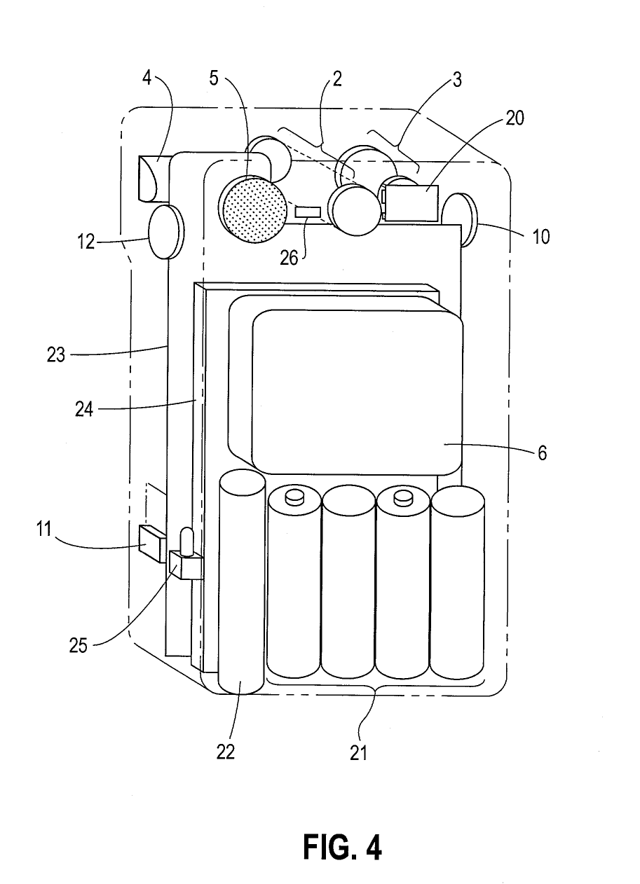

Additionally provided on the surface X1 are a photometry device 16, a red-eye reducing lamp 15 and a colorimetry device 17. The photometry device 15 measures light during the time that the red eye reducing lamp 15 is operated to reduce red eye by emitting light before causing the strobe 4 to emit. A CCD 20 (FIG. 4) is prevented from imaging the object when the red-eye reducing lamp 15 is operating. A colorimetry device 17 also measures color temperature during the time when operation of the CCD 20 is prevented. Also, a zoom switch 60 is provided to enable optical and digital zooming of the image being input, and to enable digital zooming of reproduced images.

Also provided, on the top edge section of the surface X2 (a position corresponding to the top section of the surface X1 where the viewfinder 2, the shooting lens 3 and the light emitting unit 4 are formed) which faces the surface X1, are the viewfinder 2 and a speaker 5 which outputs sound recorded in the electronic camera 1. LCD 6 and control keys 7 are formed on surface X2 below viewfinder 2, shooting lens 3, light emitting unit 4 and speaker 5. A touch tablet 6A which functions as an input means and designation means is positioned on the surface of LCD 6.

The touch tablet 6A is made of transparent material, such as glass or resin so that the user can view an image displayed on LCD 6, which is formed beneath the touch tablet 6A, through the touch tablet 6A.

Control keys 7 can be operated in order to reproduce and display recorded data on LCD 6. Control keys 7 accommodate the detection operation (input) by the user and supply the user's input to CPU 39.

A menu key 7A is operated in order to display the menu screen on the LCD 6. An execution key 7B is operated in order to reproduce the recorded information selected by the user.

A cancel key 7C is operated in order to interrupt the reproduction process of recorded information. A delete key 7D is operated in order to delete recorded information. A scroll key 7E is operated for scrolling the screen vertically when recorded information is displayed on the LCD 6 as a table.

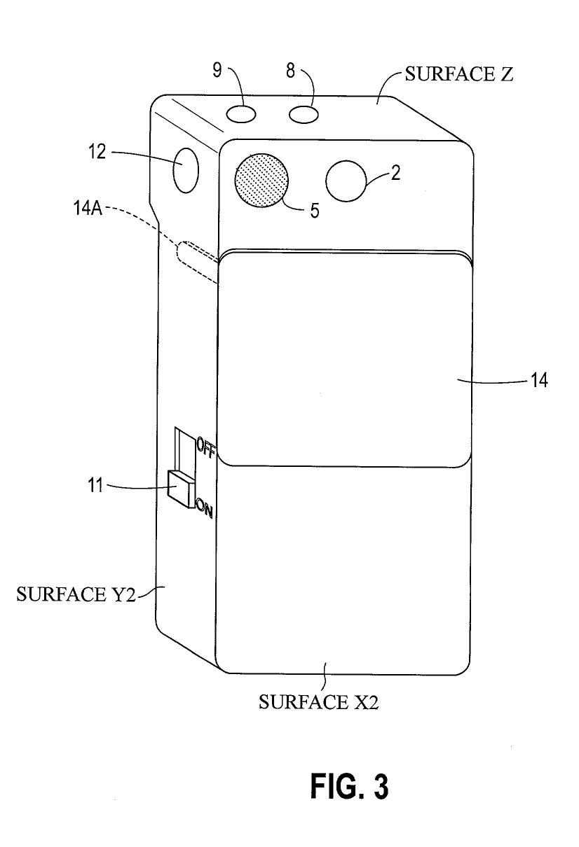

A LCD cover 14, which slides freely, is provided on the surface X2 to protect LCD 6 when it is not in use. When moved vertically upward, the LCD cover 14 covers LCD 6 and the touch tablet 6A, as shown in FIG. 3. When the LCD cover 14 is moved vertically downward, LCD 6 and the touch tablet 6A are exposed, and the power switch 11 which is arranged on the surface Y2 is switched to the on-position by the arm member 14A of the LCD cover 14.

A microphone 8, for gathering sound, and an earphone jack 9, to which an unrepresented earphone is connected, are provided in the surface Z, which includes the top surface of the electronic camera 1.

A release switch 10, which is operated when shooting an object, and a continuous shooting mode switch 13, which is operated when switching the continuous shooting mode during shooting, are provided on the left side surface Y 1. The release switch 10 and the continuous shooting mode switch 13 are positioned vertically below the viewfinder 2, shooting lens 3 and the light emitting unit 4, which are positioned on the top edge section of the surface X1.

A recording switch 12, which is operated in order to record sound, and a power switch 11 are provided on the surface Y2 (right surface) which faces opposite the surface Y1. As with the release switch 10 and the continuous shooting mode switch 13 described above, the recording switch 12 and the power switch 11 are vertically below the viewfinder 2, the shooting lens 3 and the light emitting unit 4, which are positioned on the top edge section of the surface X1. Additionally, the recording switch 12, positioned on surface Y2, and the release switch 10, positioned on the surface Y1, are formed at virtually the same height so that the user does not feel a difference when the camera is held either by the right or left hands.

Alternatively, the height of the recording switch 12 and the release switch 10 may be intentionally made different to prevent the user from accidentally pressing the switch provided in the opposite side surface when the other switch is pressed and the user's fingers hold the other side surface to offset the moment created by the pressing of the switch.

The continuous shooting mode switch 13 is used when the user decides between shooting one frame or several frames of the object by pressing of the release switch 10. For example, if the continuous shooting mode switch 13 indicator is pointed to the position printed “S” (in other words, when the switch is changed to S mode), and the release switch 10 is pressed, the camera is made to shoot only one frame.

If the indicator of the continuous shooting mode switch 13 is pointed to the position printed “L” (in other words, when the switch is changed to L mode), and the release switch 10 is pressed, the camera shoots eight frames per second as long as the release switch 10 is pressed. Thus, the low speed continuous shooting mode is enabled.

Furthermore, if the indicator of the continuous shooting mode switch 13 is pointed to the position printed “H” (in other words, when the switch is changed to H mode), and the release switch 10 is pressed, the camera shoots 30 frames per second as long as the release switch 10 is pressed. Thus, the high speed continuous shooting mode is enabled.

The internal structure of the electronic camera 1 is described next. FIG. 4 is a perspective view showing an example of an internal structure of the electronic camera shown in FIGS. 1 and 2. A CCD 20 is provided close to surface X2 behind the shooting lens 3. The optical image of the object imaged through the shooting lens 3 is photoelectrically converted to electric signals by the CCD 20.

A display device 26 located inside the viewfinder 2 is arranged inside the vision screen of the viewfinder 2 and is capable of displaying various setting conditions for various functions for viewing by the user of the object through the viewfinder 2.

Four cylindrical batteries (AAA dry cell batteries) 21 are placed side by side vertically below LCD 6 and the electric power stored in the batteries 21 is supplied to the various components of the device. A capacitor 22 is provided below LCD 6 and next to the batteries 21 to store an electric charge which is used to power the light emitting unit 4 so that light is emitted.

Various control circuits are formed on the circuit board 23 to control each component of the electronic camera 1. A removable memory card 24 is provided between the circuit board 23, the LCD 6 and the batteries 21 so that information input into the electronic camera 1 is recorded in preassigned areas of the memory card 24.

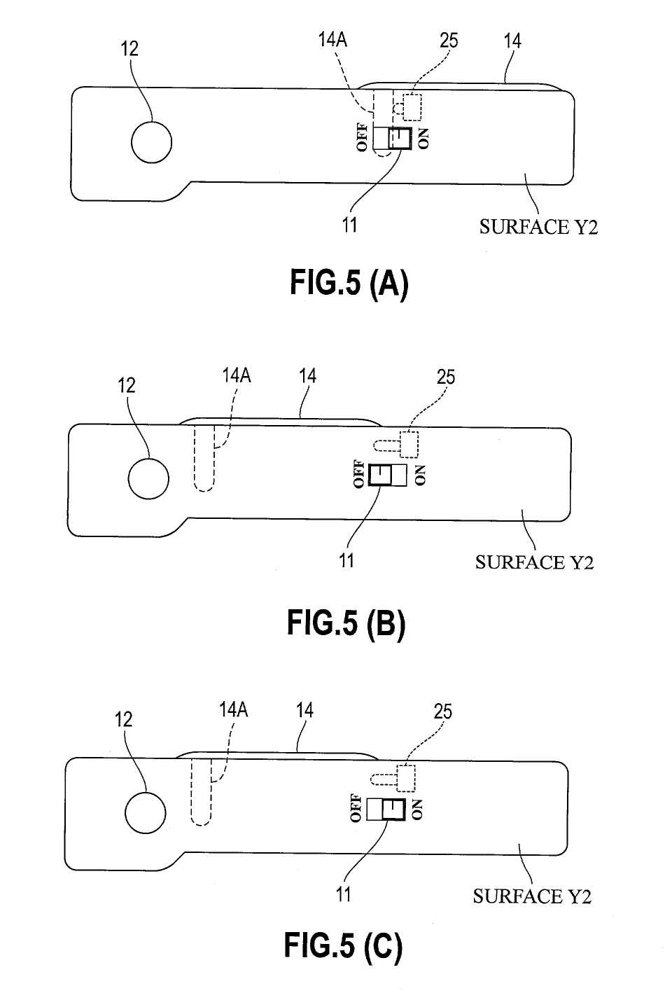

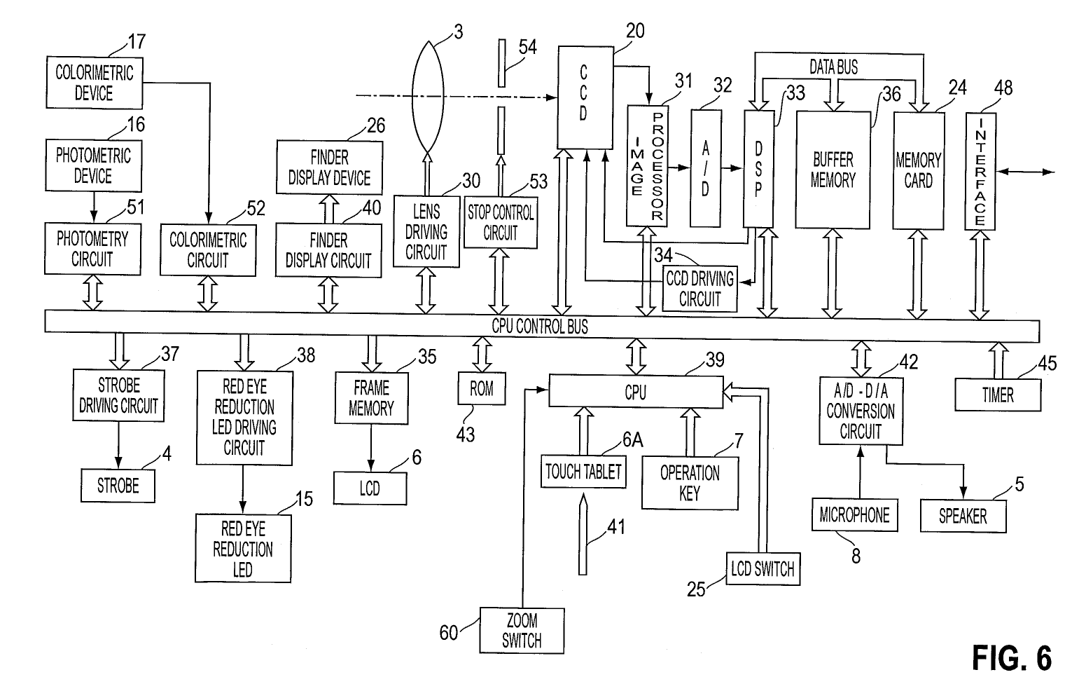

LCD switch 25, which is positioned adjacent to the power source switch 11, turns on only when the switch is pressed and is switched to ON position. The power source switch 11 is engaged by the arm member 14A of the LCD cover 14 when the LCD cover 14 is moved vertically downward, as shown in FIG. 5A.

If the LCD cover 14 moves vertically upward, the power source switch 11 can be operated by the user independent of the LCD switch 25. For example, if the LCD cover 14 is closed and the electronic camera 1 is not being used, the power source switch 11 and the LCD switch 25 are placed in off-mode as shown in FIG. 5B. In this mode, if the user switches the power source switch 11 to the on-mode, as shown in FIG. 5C, the power source switch 11 is set in the on-mode, but the LCD switch 25 continues to be in the off-mode. On the other hand, when the power source switch 11 and the LCD switch 25 are in the off-mode, as shown in FIG. 5B, and if the LCD cover 14 is opened, the power source switch 11 and the LCD switch 25 are set in the on-mode as shown in FIG. 5A. Then, when the LCD cover 14 is closed, only the LCD switch 25 is set in the off-mode as shown in FIG. 5C.

According to an embodiment of the invention, the memory card 24 is removable, but a memory in which various information can be recorded may also be provided on the circuit board 23. Moreover, various information recorded on the memory (memory card 24) may be output to an external personal computer through an interface 48.

An internal electric structure of the electronic camera 1 according to an embodiment of the invention is described hereafter with reference to the block diagram shown in FIG. 6. The CCD 20, which includes a plurality of pixels, photoelectrically converts the optical (light) image imaged on each pixel into image signals (electric signals). The digital signal processor (hereafter DSP) 33, in addition to supplying CCD horizontal driving pulses to CCD 20, also supplies CCD vertical driving pulses to CCD 20 by controlling CCD driving circuit 34.

The image processing unit 31 is controlled by CPU 39 and samples the image signals which are photoelectrically converted by CCD 20 with a predetermined timing, and also amplifies the sampled signals to a predetermined level. The CPU 39 controls each component in accordance with a control program stored in ROM (read only memory 43). The analog/digital conversion circuit (hereafter “the A/D conversion circuit”) 32 digitizes the image signals which are sampled by the image processing unit 31 and supplies them to DSP 33.

DSP 33, which controls the buffer memory 36 and the data bus connected with the memory card 24, temporarily stores image data which is supplied from the A/D conversion circuit 32 in the buffer memory 36, reads the image data stored in the buffer memory 36, and records the image data in the memory card 24.

The DSP 33 stores data in frame memory 35, supplied by the A/D conversion circuit 32, for display of the image data on the LCD 6. DSP 33 also reads the shooting image data from the memory card 24, decompresses the shooting image data and then stores the decompressed image data in the frame memory 35 to display the decompressed image data on the LCD 6.

DSP 33 also operates the CCD 20 by repeatedly adjusting the exposure time, i.e., the exposure value, until the exposure level of CCD 20 reaches an appropriate level when starting the electronic camera 1. At this time, DSP 33 may be made to operate the photometry circuit 51, and then to compute an initial exposure time value of CCD 20, which corresponds to a light receiving level detected by the photometry device 16. Adjustment of exposure time for the CCD 20 may, therefore, be achieved in a short amount of time.

In addition, the DSP 33 executes timing management for data input/output during recording on memory card 24 and storing decompressed image data on the buffer memory 36.

The buffer memory 36 is used to accommodate the difference between the data input/output speed for the memory card 24 and the processing speed of the CPU 39 and DSP 33.

The microphone 8 inputs sound information, i.e., gathered sound, and supplies the sound information to the A/D and D/A conversion circuit 42.

The A/D and D/A conversion circuit 42 converts the analog signals to digital signals, then supplies the digital signals to the CPU 39, changes the sound data supplied by CPU 39 to analog signals, and outputs the sound signal, which has been converted to an analog signal, to the speaker 5.

The photometry device 16 measures the light amount of the object and its surrounding area and outputs the measurement result to the photometry circuit 51. The photometry circuit 51 executes a predetermined process on the analog signals, which include measurement results supplied from the photometry device 16, and converts them to digital signals and outputs the digital signals to CPU 39.

The color measuring (colorimetry) device 17 measures the color temperature of the object and its surrounding area and outputs the measurement result to the colorimetry circuit 52. The colorimetry circuit 52 executes predetermined processes on the analog signals which include the color measurement results supplied from the color measuring device 17, converts them to digital signals and outputs the digital signals to CPU 39.

The timer 45 has an internal clock circuit and outputs data corresponding to the current time (time and date) to CPU 39.

The stop driving circuit 53 sets the diameter of the aperture stop 54 to a predetermined value. The stop 54 is arranged between the shooting lens 3 and the CCD 20 and changes the aperture for the light entering from the shooting lens 3 to CCD 20.

The CPU 39 prevents operation of the photometry circuit 51 and the colorimetry circuit 52 when the LCD cover 14 is open, causes operation of the photometry circuit 51 and the colorimetry circuit 52 when the LCD cover 14 is closed, and prevents the operation of the CCD 20 i.e., electronic shutter operation, until the release switch 10 reaches the half-depressed position.

The CPU 39 receives light measurement results from the photometry device 16, and receives color measurement results from the colorimetry device 17 by controlling the photometry circuit 51 and the colorimetry circuit 52 when the CCD 20 operation is stopped.

The CPU 39 also computes a white balance adjustment value using a predetermined table which corresponds to the color temperature supplied from the colorimetry circuit 52, and supplies the white balance value to the image processing unit 31.

In other words, when the LCD cover 14 is closed, the LCD 6 is not used as an electronic viewfinder and hence, the CCD 20 operation is stopped. The CCD 20 consumes a large amount of electric power, hence by stopping operation of CCD 20, as described above, the battery power is conserved. When LCD cover 14 is closed, the image processing unit 31 is controlled in such manner that the image processing unit 31 does not execute various processes until the release switch 10 is operated, i.e., until the release switch 10 assumes the half-depressed state. When LCD cover 14 is closed, the stop driving circuit 53 is controlled in such a manner that the stop driving circuit 53 does not execute operations, such as changing the diameter of the aperture stop 54, until the release switch 10 is operated, i.e., until the release switch 10 reaches the half-depressed state.

The CPU 39 causes the strobe 4 to emit light, at the user's discretion, by controlling the strobe driving circuit 37, and also causes the red eye reduction lamp 15 to emit light, at the user's discretion, prior to causing the strobe 4 to emit light by controlling the red eye reduction lamp driving circuit 38. In this instance, the CPU 39 does not permit the emission of light when the LCD cover 14 is open, in other words, when the electronic viewfinder is used. By doing this, the object may be shot as an image displayed in the electronic viewfinder.

The CPU 39 records information, including the date of shooting, as header information of the image data in a shooting image recording area of the memory card 24 according to the date data supplied from the timer 45. In other words, date data is attached to the shooting image data recorded in the shooting image recording area of the memory card 24.

Additionally, the CPU 39 temporarily records the digitized and compressed sound data after compressing the digitized sound information to the buffer memory 36, and then records it in a predetermined area, i.e., sound recording area, of the memory card 24. The data concerning the recording date is also recorded in the sound recording area of the memory card 24 as header information of the sound data.

The CPU 39 executes the auto focus operation by controlling the lens driving circuit 30 to move the shooting lens 3, and by changing the aperture diameter of the stop 54, which is positioned between the shooting lens 3 and the CCD 20, by controlling the stop driving circuit 53.

The CPU 39 also displays settings for various operations on the in-viewfinder display device 26 by controlling the in-viewfinder display circuit 40.

The CPU 39 exchanges data with external apparatus (unrepresented) through an interface (I/F) 48. The CPU 39 receives signals from the control keys 7 and processes them appropriately.

When a predetermined position in the touch tablet 6A is pressed by the pen, i.e., a pen type pointing member 41 operated by the user, the CPU 39 reads the X-Y coordinates of the position being pressed by the touch tablet 6A and stores the coordinate data, i.e., memo information described in greater detail later, in the buffer memory 36. The CPU 39 records information stored in the buffer memory 36 in the memo information recording area of the memory card 24 together with header information including the memo information input date.

Next, various operations of the electronic camera 1 according to an embodiment of the invention will be described. The operations of the electronic viewfinder in LCD 6 will first be described in detail.

When the user half-depresses the release switch 10, DSP 33 determines whether or not the LCD cover 14 is open, based on the value of the signal corresponding to the status of the LCD switch 25, which is supplied from CPU 39. If the LCD cover 14 is determined to be closed, the operation of the electronic viewfinder is not executed. In this case, DSP 33 stops the process until the release switch 10 is operated.

If the LCD cover 14 is closed, the operations of the electronic viewfinder are not executed, and hence, CPU 39 stops the operation of the CCD 20, the image processing unit 31 and the stop driving circuit 53. The CPU 39 causes the photometry circuit 51 and the colorimetry circuit 52 to operate and supplies the measurement results to the image processing unit 31. The image processing unit 31 uses the measurement result values to control white balance and the brightness value.

Until the release switch 10 is operated, the CPU 39 prevents the CCD 20 and the stop driving circuit 53 from operating.

On the other hand, if the LCD cover 14 is open, the CCD 20 executes the electronic shutter operation with predetermined exposure time for each predetermined time interval, executes photoelectric conversion of the photo image of the object, which is gathered by the shooting lens 3, and outputs the resulting image signals to the image processing unit 31.

The image processing unit 31 controls white balance and brightness value, executes predetermined processes on the image signals, and then outputs the image signals to the A/D conversion circuit 32. If the CCD 20 is operating, the image processing unit 31 uses an adjusted value which is computed based on the output from the CCD 20 by the CPU 39 and which is used for controlling of white balance and brightness value.

Furthermore, the A/D conversion circuit 32 converts the image signal, i.e., an analog signal, into the image data which is a digital signal, and outputs the image data to DSP 33.

The DSP 33 outputs the image data to the frame memory 35 and causes the LCD 6 to display an image corresponding to the image data.

In this manner, the CCD 20 operates the electronic shutter with a predetermined time interval when the LCD cover 14 is open, and executes the operation of the electronic viewfinder by converting the signal output from the CCD 20 into image data each time, outputting the image data to the frame memory 35 and continuously displaying the image of the object on LCD 6.

If the LCD cover 14 is closed as described above, the electronic viewfinder operation is not executed and operation of the CCD 20, the image processing unit 31 and the stop driving circuit 53 are halted to conserve energy.

Shooting images of an object according to an embodiment of the invention will be described next.

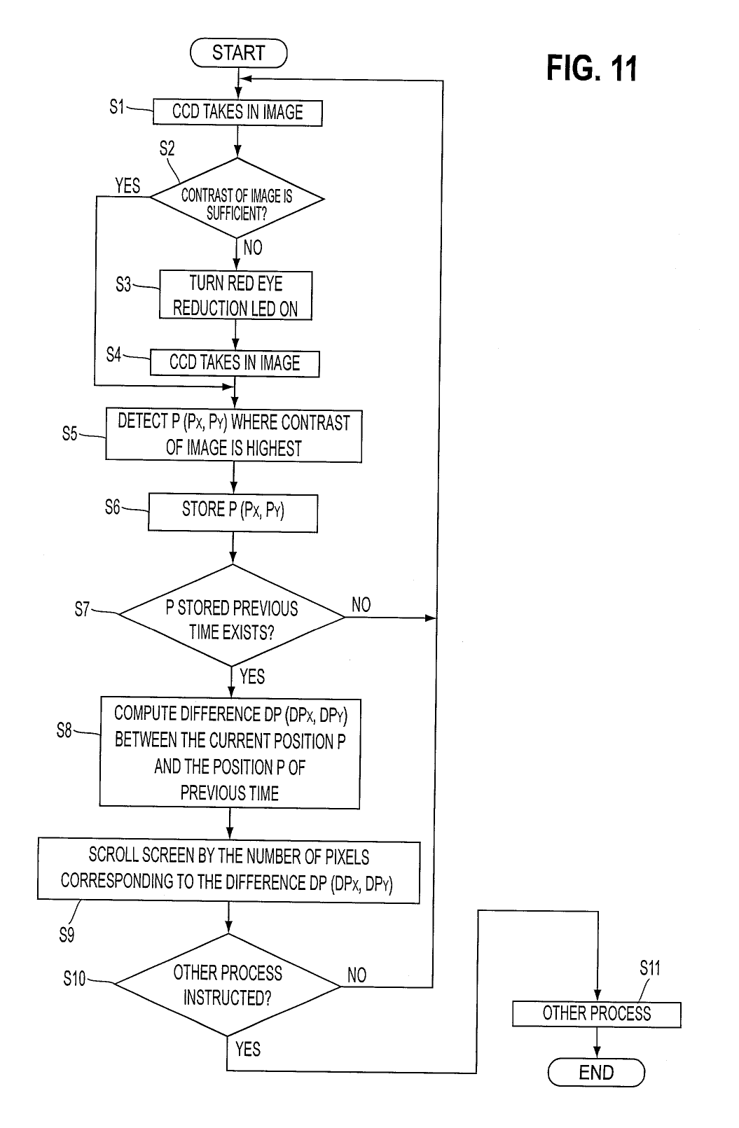

First, switching the continuous shooting mode switch 13 positioned on surface Y1, to the S-mode, i.e., the mode in which only one frame is shot, will be explained. Power is introduced to the electronic camera 1 by switching the power source switch 11, shown in FIG. 11 to the “ON” position. The process of shooting an image of the object begins when the release switch 10 positioned on the surface Y1, is pressed after verifying the object with the viewfinder 2.

If the LCD cover 14 is closed, the CPU 39 starts operation of CCD 20, the image processing unit 31 and the stop driving circuit 53 when the release switch 10 is in the half-depressed status. The process of shooting the image begins when the release switch 10 reaches the fully-depressed status.

The image of the object observed through the viewfinder 2 is gathered by the shooting lens 3 and forms an image on the CCD 20, which includes a plurality of pixels. The photo image imaged on the CCD 20 is photoelectrically converted into image signals by each pixel and is sampled by the image processing unit 31. The image signal, which is sampled by the image processing unit 31, is supplied to the A/D conversion circuit 32, where it is digitized, and is output to DSP 33.

The DSP 33, after outputting the image temporarily to the buffer memory 36, reads the image data from the buffer memory 36, compresses the image data using the JPEG (Joint Photographic Experts Group) standard, which is a combination of discrete cosine transformation, quantization, and Huffman encoding, and records the image data in the shooting image recording area of the memory card 24. At this time, the shooting date data is recorded as header information of the shooting image data in the shooting image recording area of the memory card 24.

If the continuous shooting mode switch 13 is switched to the S-mode, only one frame is shot and additional shooting does not take place even if the release switch 10 is continued to be pressed. Additionally, if the release switch 10 is continued to be pressed, the image which has been shot is displayed on the LCD when the LCD cover 14 is open.

The case in which the continuous shooting mode switch 13 is switched to L-mode (a mode in which 8 frames per second are shot continuously) is described as follows. Power is introduced to the electronic camera 1 by switching the power source switch 11 to the “ON” side. The image shooting process begins when the release switch 10 is pressed.

In this instance, if the LCD cover 14 is closed, the CPU 39 starts operation of CCD 20, the image processing unit 31 and the stop driving circuit 53 when the release switch 10 is in the half-depressed position, and begins the process of shooting the object when the release switch 10 reaches the fully-depressed position.

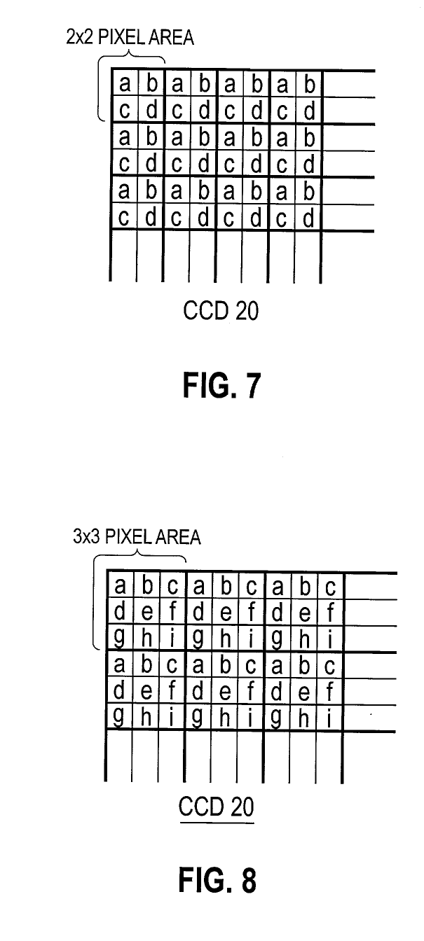

The photo image of the object observed through the viewfinder 2 is gathered by the shooting lens 3 and forms an image on CCD 20. The photo image which is imaged onto CCD 20 is photoelectrically converted into image signals by each pixel, and is sampled by the image processing unit 31 with a rate of 8 times per second. The image processing unit 31 thins out three-fourths of the pixels of the image signals of all of the pixels in the CCD 20. In other words, the image processing unit 31 divides the pixels in CCD 20 into areas of 2×2 pixels (4 pixels) as shown in FIG. 7, and samples the image signal of one pixel arranged at a predetermined location from each area, thinning out the remaining 3 pixels.

For example, during the first sampling, i.e., first frame, the pixel a, located on the left upper comer, is sampled and other pixels b, c and d are thinned out. During the second sampling, i.e., second frame, the pixel b located on the right upper comer is sampled and the other pixels a, c and d are thinned out. Likewise, during the third and the fourth samplings, the pixels c and d, which are respectively located at the left lower comer and the right corner are sampled and the rests are thinned out. In short, each pixel is sampled once during four samplings.

The image signals (image signals of one-fourth of all the pixels in CCD 20) that are sampled by the image processing unit 31 are supplied to the A/D conversion circuit 32 where they are digitized and output to DSP 33.

The DSP 33, after outputting the image temporarily to the buffer memory 36, reads the image data from the buffer memory 36, compresses the image data using the JPEG method, and records the digitized and compressed shooting image data in the shooting image recording area of the memory card 24. At this time, the shooting date data is recorded as header information of the shooting image data in the shooting image recording area of the memory card 24.

Next, the case in which the continuous shooting mode switch 13 is switched to the H-mode, i.e., a mode in which 30 frames are shot per second, is described. Power is introduced to the electronic camera 1 by switching the power source switch 11 to the “ON” position. The process of shooting the object begins when the release switch 10 is pressed.

In this instance, if the LCD cover 14 is closed, the CPU 39 starts operation of CCD 20, the image processing unit 31 and the stop driving circuit 53 when the release switch 10 is in the half-depressed position, and begins the process of shooting the object when the release switch 10 reaches the fully-depressed position.

The light image of the object observed through the viewfinder 2 is gathered by the shooting lens 3 and is imaged on CCD 20. The light image of the object imaged on the CCD 20 is photoelectrically converted to an image signal by each pixel and is sampled 30 times per second by the image processing unit 31. At this time, the image processing unit 31 thins out eight-ninths of the pixels in the image electric signals of all the pixels in the CCD 20.

In other words, the image processing unit 31 divides the pixels in the CCD 20 which are arranged in a matrix into areas comprising 3×3 pixels (9 pixels) as shown in FIG. 8, and samples, at a rate of 30 times per second, image signals of one pixel which is arranged in a predetermined position in each area. The remaining 8 pixels are thinned out.

For example, during the first sampling, i.e., first frame, the pixel a, located on the left upper comer of each area, is sampled and the other pixels b through i are thinned out. During the second sampling, i.e., second frame, the pixel b, located to the right of pixel a is sampled and the other pixels, a and c through i are thinned out. Likewise, during the third and the fourth samplings etc., the pixel c, the pixel d, etc., are sampled, respectively, and the rests are thinned out. In short, each pixel is sampled once for every nine frames.

The image signals, i.e., image signals of one-ninth of all the pixels in CCD 20 that are sampled by the image processing unit 31 are supplied to the A/D conversion circuit 32 where they are digitized and are output to DSP 33. The DSP 33, after outputting the image temporarily to the buffer memory 36, reads the image data, compresses the image data using the JPEG method, and records the digitized and compressed shooting image data in the shooting image recording area of the memory card 24.

In this instance, light may be shined on the object, if necessary, by operating the strobe 4. However, when the LCD cover 14 is open, or when LCD 6 executes the electronic viewfinder operation, the CPU 39 controls the strobe 4, preventing it from emitting light.

Next, an operation in which two dimensional memo information is input from the touch tablet 6A is described.

When the touch tablet 6A is pressed by the tip of the pen 41, the X-Y coordinate of the contact point is supplied to CPU 39. The X-Y coordinate is stored in the buffer memory 36. Moreover, CPU 39 writes data of the address in the frame memory 35, which corresponds to each X-Y coordinate, and the memo information corresponding to contact point of the pen 41 is displayed on the LCD 6.

As described above, the touch tablet 6A is made of transparent material and the user is able to view the point, i.e., the point of the location being pressed by the tip of the pen 41 being displayed on LCD 6, which gives an impression that the input is made by the pen directly onto LCD 6. When the pen 41 is moved on the touch tablet 6A, a line tracing the motion of the pen 41 is displayed on LCD 6. If the pen 41 is moved intermittently on the touch tablet 6A, a dotted line tracing the motion of the pen 41 is displayed on LCD 6. In this manner, the user is able to input memo information of desired letters and drawings to the touch tablet 6A.

If the memo information is input by the pen 41 when the shooting image is already displayed on LCD 6, the memo information is synthesized (combined) with the shooting image information by the frame memory 35 and are displayed together on LCD 6. By operating a predetermined pallet (not shown), the user is able to choose the color of the memo information to be displayed on LCD 6 from black, white, red, blue and other colors.

If the execution key 7B is pressed after memo information is input to the touch tablet 6A by the pen 41, the memo information accumulated in the buffer memory 36 is supplied with header information of the input date to the memory card 24 and is recorded in the memo information recording area of the memory card 24.

In this instance, the memo information recorded in the memory card 24 includes compressed information. The memo information input in the touch tablet 6A contains information with high spatial frequency components. Hence, if the aforementioned JPEG method is used to compress the line drawing information, compression efficiency becomes poor and an amount of information is not reduced, resulting in a longer time for compression and decompression. Moreover, compression by the JPEG method is lossey. Hence, it is not suitable for compression of memo information, which has a small amount of information. This is because gather and smear due to missing information become noticeable when the information is decompressed and displayed on LCD 6.

Hence, according to an embodiment of the invention, memo information is compressed using the run length method used in facsimile machines and similar devices. The run length method is a method in which the memo screen is scanned in the horizontal direction and the memo information is compressed by encoding each continuous length of information of each color such as black, white, red and blue, as well as each continuous length of non-information, i.e., where there is no pen input.

Using the run length method, memo information is compressed to minimize the amount of information that is lost when the compressed memo information is decompressed. Moreover, it is possible to forego compression of the information if the amount of information is relatively small.

As mentioned above, if the memo information is input by the pen when the shooting image is already displayed on LCD 6, the pen input is synthesized with the shooting image information by the frame memory 35 and the synthesized image of the shooting image and memo information is displayed on LCD 6. Also, the shooting image data is recorded in the shooting image recording area of the memory card 24 and the memo information is recorded in the memo information area of the memory card 24. In this manner, two types of information are recorded separately. Hence, the user may be able to delete one of the two images, i.e., the line drawing, from the synthesized image of shooting image and memo information. Additionally, further compression of each type of image information by a separate compression method is possible.

When data is recorded in the sound recording area, the shooting image recording area, or the memo information recording area of the memory card 24, a table containing the data may be displayed on LCD 6.

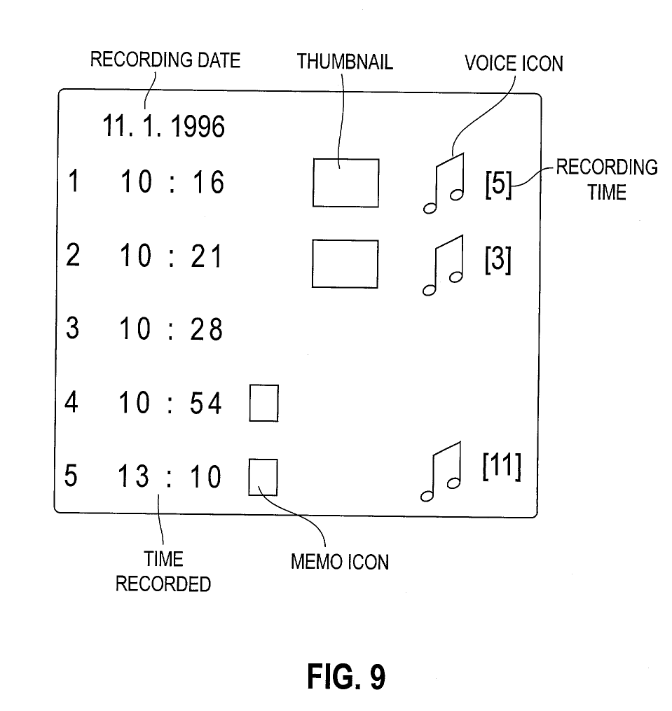

As shown in FIG. 9, the date of recording information, i.e., recording date, Nov. 1, 1996 in this case, is displayed on the top section of the LED display screen. The recording time of the information recorded on that recording date is displayed on the left-most side of the LCD display screen. A separate recording time is displayed for each recording unit. Each recording unit can have one or more of shooting image data, memo information or sound information.

A thumbnail image (icon) is displayed to the right of the time of recording. The thumbnail image is formed by thinning (reducing) the bit map data of image data of the shooting image data recorded in the memory card 24. In the present example, information recorded, i.e., input, at “10:16” and “10:21” contains the shooting image information, but information recorded at the other times does not contain image information.

A memo icon indicates that the predetermined memo information is recorded as line drawing information.

A sound icon (musical note) is displayed to the right of the thumbnail image display area with the recording time (in seconds) displayed on the right of the sound icon. These are not displayed if the sound information is not input.

The user selects and designates information to be reproduced by pressing, with the tip of the pen 41, the desired sound icon in the table displayed on the LCD 6 as shown in FIG. 9. The selected information is reproduced by pressing, with the tip of the pen 41, the execution key 7B shown in FIG. 2.

For example, if the sound icon at “10:16” shown in FIG. 9 is pressed by the pen 41, the CPU 39 reads sound data corresponding to the selected recording date (10:16) from the memory card 24, decompresses the sound data, and then supplies the sound data to the A/D and D/A conversion circuit 42. The A/D and D/A conversion circuit 42 converts the data to analog signals, and then reproduces the sound through the speaker 5.

In reproducing the shooting image data recorded in the memory card 24, the user selects the information by pressing the desired thumbnail image with the tip of the pen 41, then reproduces the selected information by pressing the execution key 7B.

In other words, the CPU 39 instructs DSP 33 to read the shooting image data corresponding to the selected thumbnail image shooting date and time from the memory card 24. The DSP 33 decompresses the shooting image data, i.e., compressed shooting data which is read from the memory card 24 and accumulates the shooting image data as bit map data in the frame memory 35 which then is displayed on the LCD 6.

The image which is shot with the S-mode is displayed as a still image on the LCD 6. This still image is obviously the image reproduced from the image signals of all the pixels in CCD 20.

The image which is shot with L-mode is displayed continuously (i.e., as moving pictures) at 8 frames per second on the LCD 6. In this case, the number of pixels being displayed in each frame includes one fourth of all the pixels in CCD 20. Human vision is sensitive to deterioration of still image resolution. Hence, users can easily detect the thinning of the pixels in the still image. However, the shooting speed is increased in the L-mode where images of 8 frames are reproduced per second. Thus even though the number of pixels in each frame becomes one-fourth of the number of pixels of CCD 20, information amount per unit of time doubles compared to the still image because human eyes observe images of 8 frames per second.

In other words, assuming the number of pixels of one frame of the image which is shot with S-mode to be one, the number of pixels in one frame of the image which is shot with L-mode becomes one-fourth. When the image i.e., still image, which is shot with S-mode is displayed on LCD 6, the amount of information viewed by the human eye per second is 1 (=(number of pixels 1)×(number of frames 1)). On the other hand, when an image which is shot in the L-mode is displayed on LCD 6, the amount of information viewed by the human eye per second is 2 (=(number of pixels 1/4)×(number of frames 8)). Therefore, twice as much information is viewed by the human eye. Hence, even when the number of pixels in one frame is reduced to one-fourth, the user does not notice much deterioration of the image quality during reproduction.

According to an embodiment of the invention, different sampling is executed (i.e., a different pixel is sampled) for each frame and the sampled pixels are made to be displayed on LCD 6. Hence, an after-image effect occurs on the human eye, and the user can view the image which is shot with L-mode and which is displayed on LCD 6 without noticing deterioration of the image, even when three-fourths of the pixels are thinned out per one frame.

The image shot with the H-mode is displayed on the LCD 6 at 30 frames per second. At this time, the number of pixels displayed in each frame is one-ninth of the total number of the pixels of CCD 20. However, the user can view the image shot with the H-mode and displayed on LCD 6 without noticing much deterioration of image quality for the same reasons as in the case of the L-mode.

According to an embodiment of the invention, when the object is shot in the L-mode or H-mode, because the image processing unit 31 is made to thin out the pixels in CCD 20 in such a manner that the user does not notice deterioration of the image quality during reproduction, the load on DSP 33 and the CCD drive circuit 34 is reduced, enabling the speed low and low power operation of these units. Moreover, low cost and low energy consumption operation of the apparatus may be achieved.

In this embodiment, it is possible to record memo (line drawing) information in addition to shooting photo image information of the object as described earlier. In the present embodiment, modes (shooting mode and memo input mode) are input information, which is appropriately selected depending on the operation by the user. Hence, input of information is executed smoothly.

Next, a method for scrolling the image and moving the cursor displayed on the screen of the electronic camera 1 by holding the electronic camera in a hand and by moving and rotating the electronic camera 1 is described.

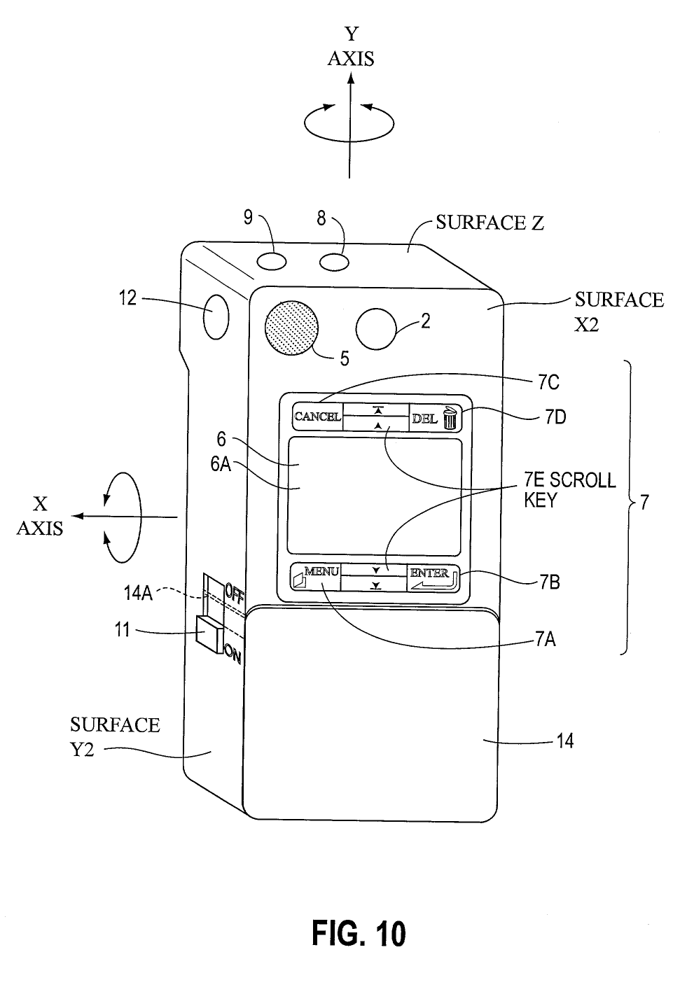

Here, a rotational axis for rotating the electronic camera 1 is defined as shown in FIG. 10. In other words, a line connecting the center of the electronic camera 1 and the center of surface Z is defmed as the Y-axis (a vertical axis of the camera), and a line connecting the center of the electronic camera 1 to the center of surface Y2 is defmed as the X-axis (the horizontal axis of the camera). The user can rotate the electronic camera around these two axes.

FIG. 11 is a flow chart showing an example of a process executed for detecting movement and rotation of the electronic camera 1 based on an image shot by the CCD 20 shown in FIG. 6. In step S 1, the image is taken in by the CCD 20. The CPU 39 controls the image processing unit 31 and samples the image signals which are photoelectrically converted by the CCD 20 according to a predetermined timing. The sampled image signals are converted into digital image data at the A/D conversion circuit 32 and are temporarily supplied to the buffer memory 36 by the DSP 33. Then the image data stored in the buffer memory 36 by the DSP 33 is read and compressed, after which the compressed image data is supplied to and stored in the memory card 24.

Next, at step S2, the CPU 39 determines whether the contrast of the image taken in step S1 is sufficient. The CPU 39 determines whether or not the section of the image with the highest contrast can be detected from the image taken in step S1. For example, if the background is completely black, an image with contrast cannot be detected. If CPU 39 determines that the section with the highest contrast may be detected, the CPU 39 moves to step S5.

On the other hand, if the CPU 39 determines that the section with the highest contrast cannot be detected, the CPU 39 moves to step S3, where the CPU 39 controls the LED driving circuit 38 and turns on the red eye reduction LED 15. By doing this, light is shined on the object located on the surface X1 side of the electronic camera 1. Next, at step S4, the CPU 39 controls CCD 20 which takes the image in the same manner as described above. In this case, the red eye reduction LED 15 is on, hence, the image being taken has contrast, enabling detection of the section with the highest contrast. When CCD 20 completes taking the image, the CPU 39 controls the red eye reduction LED driving circuit 38 and turns off the red eye reduction LED 15.

At step S5, the CPU 39 selects the section of the image with the highest image contrast stored in the memory card 24, and the coordinate P1 (Px, Py) of this section is stored in the buffer memory 36, for example, in step S6.

Next, at step S7, CPU 39 determines whether or not the coordinate P0 corresponding to the section with the highest contrast previously stored is found. If CPU 39 determines that the coordinate P0 previously stored is not found, the CPU 39 returns to step S1 and repeats the process at step S1 and continues. A cycle of executing steps S1 through S7 may be made at 30 hertz (Hz), for example, to match the cycle of taking in the image. Hence, the red eye reduction LED 15 flashes intermittently with a cycle of 30 hertz (Hz).

If the background is completely dark, illumination light may be shined on the background using an illumination apparatus in place of the red eye reduction LED 15 to enable taking in of an image with contrast by the CCD 20.

If CPU 39 determines that the coordinate P0 stored previously is found, the CPU 39 moves to step S8 where the CPU 39 computes the difference DP(DPx, DPy) between the coordinate P0, which was stored previously and the coordinate P1 which is currently detected.

Next, the CPU 39 moves to step S9 and scrolls the reproduced image which is displayed on the screen by a predetermined number of pixels in a predetermined direction corresponding to the difference DP(DPx, DPy).

For example, suppose that the number of pixels in the horizontal direction of CCD 20 is 640 and the number of pixels in the horizontal direction of LCD 6 is 280 and that LCD 6 is structured to be able to display the entire shooting range of CCD 20. Moreover, suppose that the image of the object which is detected by CCD 20 is detected to have moved to the left due to swinging of camera to the right by 64 pixels, which is equivalent to 1/10 of the total pixels of CCD 20 in horizontal direction. In this case, the image on LCD 6 may be scrolled to the left by 28 pixels which is 1/10 of the total number of pixels in horizontal direction. Moreover, if the electronic camera 1 is swung in vertical direction, the screen which is displayed on LCD 6 may be scrolled vertically in basically similar manner as the case in which the electronic camera 1 is swung horizontally.

By doing this, the reproduced image may be scrolled to give an impression as if the shooting screen is moved by swinging the electronic camera vertically and horizontally during reproduction in the similar manner as the shooting screen is moved when the electronic camera 1 is swung vertically and horizontally while the user is monitoring the shooting screen through the LCD 6 during the shooting. Of course, the user may be able to make the above setting a default setting and to make the relationship between the amount of movement and amount of scrolling of the screen being shot by CCD 20 variable, which may be set by the user.

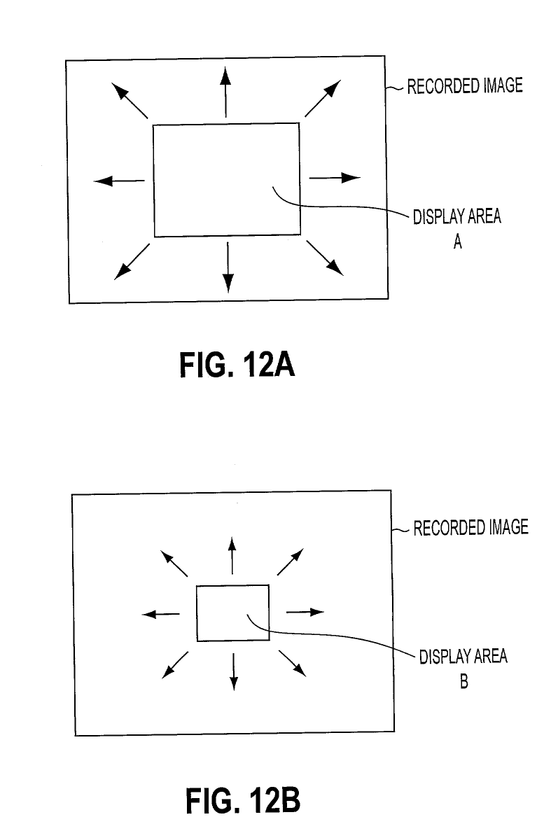

Referring to FIG. 12A, assume that a recorded image is displayed in a zoom condition such that display area A of the image is displayed in the LCD 6. When the user rotates the electronic camera around the Y-axis, the display area A virtually moves horizontally on the recorded image, and as a result, the image being displayed on LCD 6 scrolls horizontally. Likewise, when the user rotates the electronic camera 1 around the X-axis, the display area A moves vertically on the recorded image, and, as a result, the image displayed on LCD 6 scrolls vertically.

By giving the electronic camera 1 a rotation which is a combination of rotation around the X-axis and rotation around the Y-axis, the display area A may be virtually moved in any arbitrary direction on the recorded image. Hence, the image being displayed on LCD may be scrolled in any arbitrary direction.

When the user operates the zoom-up switch 60 shown in FIG. 1, to zoom the image displayed on LCD 6 under the condition that a display area A is set in the recorded image and that the image in the display area A is displayed in LCD 6 as shown in FIG. 12A, a display area B, which is smaller than the display area A, is set virtually on the image screen as shown in FIG. 12B. Moreover, the image in the display area B is displayed over the entire screen of LCD 6. In other words, the image is enlarged.

Even in the case where the image is enlarged, as shown in FIG. 12B, by rotating the electronic camera 1, as described above with respect to FIG. 12A, the display area B may be virtually moved in any arbitrary direction on the recorded image, which, in turn, causes the enlarged image displayed on LCD 6 to be scrolled in any arbitrary direction. An enlargement of the reproduced image may, therefore, be achieved by operating the zoom switch 60, as shown in FIG. 1.

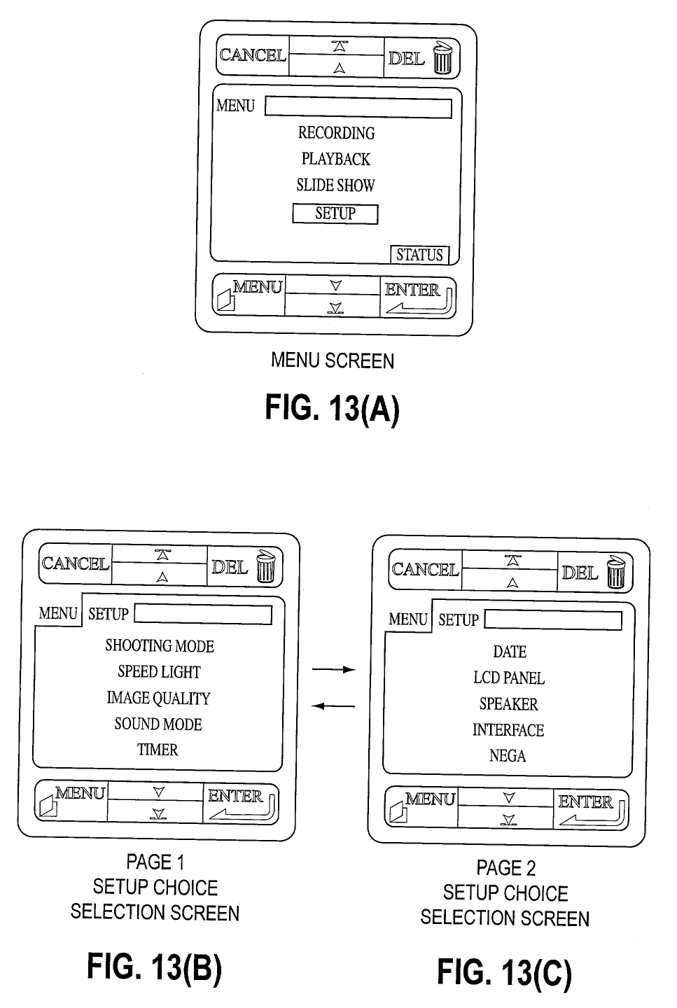

As shown in FIG. 13A, in a menu screen where a predetermined selection choice and a cursor are displayed, the cursor may be moved by moving or rotating the electronic camera 1 and a specific item may be selected. In this case, each choice, “Recording”, “Play back”, “Slide show”, and “Set up” is arranged vertically, and the cursor moves vertically by movement and rotation of the electronic camera 1. For example, by selecting the execution key 7B and by pressing the release switch 10, whereby the cursor is moved to the choice “Set up” by rotating the electronic camera 1 around the X-axis, the “Set up” option may be selected. By doing this, a set up choice shown in FIG. 13B is displayed on the screen of LCD 6.

The set up choice in this example is displayed over two pages, and the first page and the second page may be switched by rotating the electronic camera 1 in the direction of the X-axis. The user may display the page with the desired set up choice and may select the choice by using the pen 41, for example, by pressing the release switch 10 or selecting the execution key 7B after moving the unrepresented cursor through rotation of the camera.

Next, at step S10 shown in FIG. 11, the CPU 39 determines whether or not execution of another process is selected by the user. If the CPU 39 determines that execution of another process is not selected, the CPU 39 returns to step S1 and repeats the process at step S1. However, if the CPU 39 determines that execution of another process is selected by the user, CPU 39 moves to step S1, and executes and completes the other process.

Hence, because the image being displayed on the screen can easily be scrolled and the cursor can easily be moved by rotating the electronic camera 1, the operability of portable equipment, in particular, may be improved.

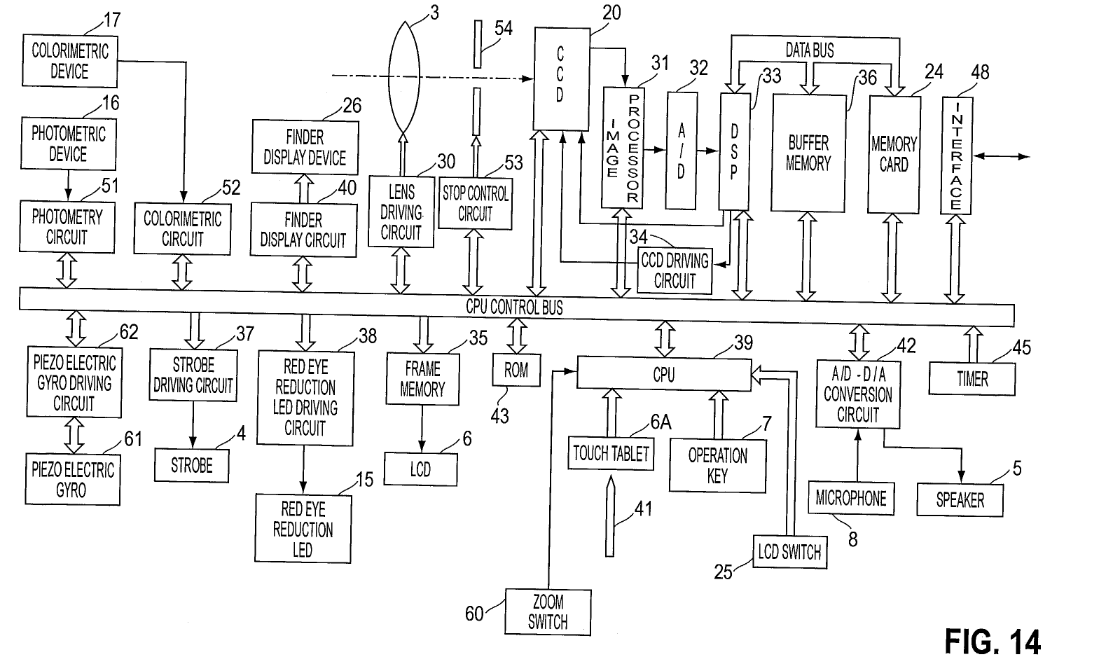

FIG. 14 is a block diagram showing an internal electric structure according to an embodiment of the invention. In this embodiment, a piezoelectric gyro 61 and a piezoelectric gyro driving circuit 62 are incorporated into the embodiment shown in FIG. 6. The remaining structural and operational conditions are the same as those shown in FIG. 6.

The piezoelectric gyro 61 detects the angular velocity of rotation with respect to two axes and outputs corresponding signals. The piezoelectric gyro driving circuit 62 supplies electric power to the piezoelectric gyro 61 and supplies signals from the piezoelectric gyro 61 to the CPU 39.

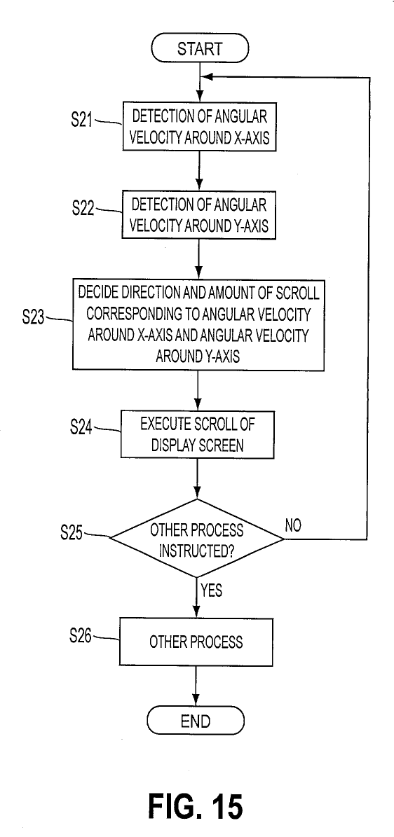

The processes by which rotation of the electronic camera 1 is detected by the piezoelectric gyro 61, an image displayed on the screen is scrolled and the cursor is moved will be described with reference to the flow chart shown in FIG. 15.

At step S21, signals corresponding to the angular velocity of rotation with respect to the X-axis detected by the piezoelectric gyro 61 are supplied to the CPU 39 through the piezoelectric gyro driving circuit 62. At step S22, signals corresponding to the angular velocity of rotation with respect to Y-axis detected by the piezoelectric gyro 61 is supplied to the CPU 39 through the piezoelectric gyro driving circuit 62. Next, the CPU 39 moves to step S23 where the CPU 39 computes the direction and the amount of scroll of the image corresponding to the angular velocity of the rotation with respect to X-axis and the angular velocity of the rotation with respect to Y-axis which were detected at steps S21 and S22.

The relationship between the angular velocity and the amount of scroll may be established as follows. The shooting angle of the shooting lens 3 in the horizontal direction is q, the number of pixels of the LCD 6 in the horizontal direction is 280 pixels, and the entire shooting range is displayed on the LCD 6. If rotation of the electronic camera 1 by q/10 around the X-axis is detected from the angular velocity, for example, the image displayed in LCD 6 may move vertically by 28 pixels, which is 1/10 of the number of pixels in the horizontal direction. Moreover, when the rotation of electronic camera 1 around the Y-axis is detected from the angular velocity, the image being displayed in the LCD 6 may move horizontally in a manner similar to the case in which the electronic camera 1 is rotated around the X-axis.

By doing this, the reproduced image may be scrolled giving the impression that the shooting screen is moved by swinging the electronic camera vertically and horizontally during reproduction in a similar manner as the shooting screen is moved when the electronic camera 1 is swung vertically and horizontally while the user is monitoring the shooting screen through the LCD 6 during shooting. Of course, the user may be able to make the above setting a default setting and make the relationship between the amount of rotation of the electronic camera 1 and amount of scrolling of the screen being displayed in LCD 6 variable, which may be set by the user.

At step S24, the image being displayed in the screen of LCD 6 may be scrolled and the cursor being displayed in the screen of LCD 6 may be moved, in the same manner as the case described above in reference to FIGS. 12 and 13, and according to the direction and amount of scroll computed at step S23.

In this manner, the rotation of the electronic camera 1 may be detected by the piezoelectric gyro 61, and the image displayed in the screen of LCD 6 may be scrolled and the cursor displayed in the screen of LCD 6 may be moved corresponding to the rotation of the electronic camera 1 by the user.

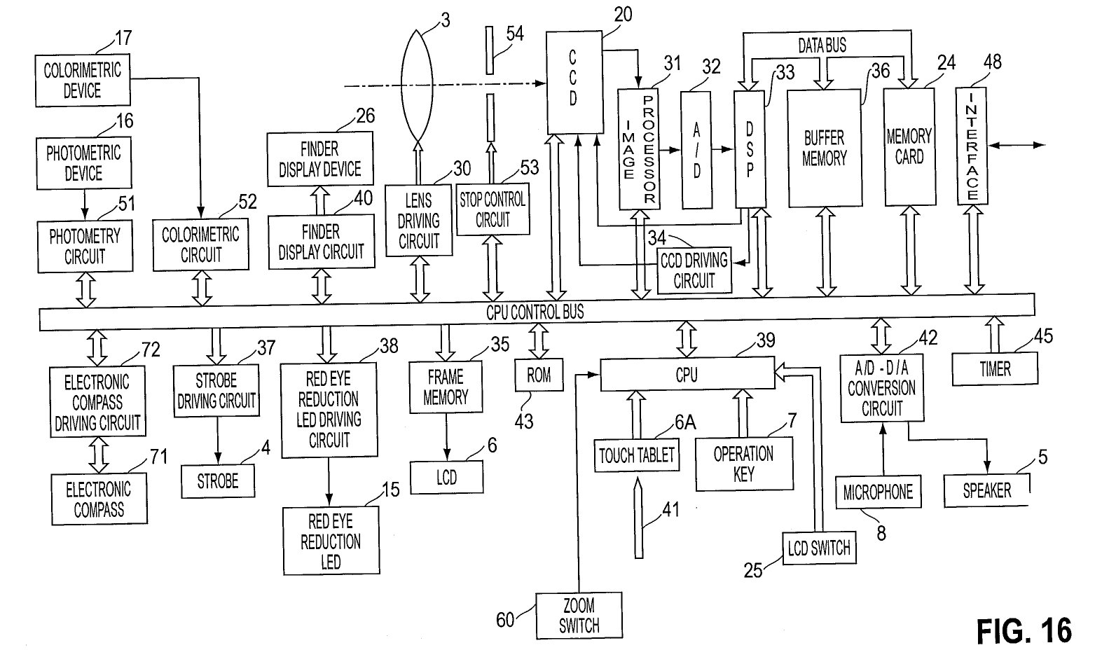

FIG. 16 is a block diagram showing an electric structure according to another embodiment of the invention. In this embodiment, an electronic compass 71 and an electronic compass driving circuit 72 are incorporated into the embodiment shown in FIG. 6. The remaining structural and operational conditions are the same as those shown in FIG. 6.

The electronic compass 71 can be a magnetic device, such as a Hall device, and detects surface magnetism in order to determine bearings. The electronic compass driving circuit 72 supplies power to the electronic compass 71 and supplies signals corresponding to the bearings detected by the electronic compass 71 to the CPU 39.

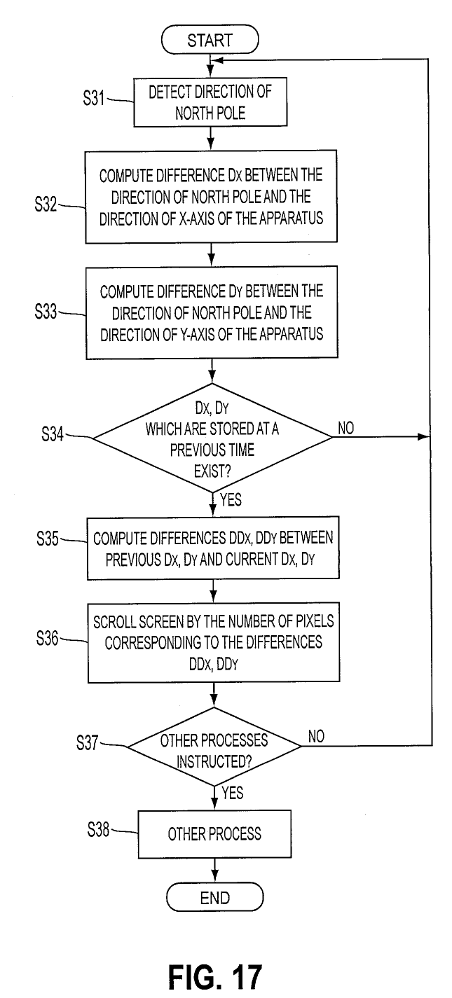

The processes by which rotation of the electronic camera 1 is detected by the electronic compass 71, an image being displayed on the screen is scrolled and the cursor is moved will be described with reference to the flow chart shown in FIG. 17.

At step S31, the direction of North pole is detected by the electronic compass 71. The signals corresponding to the direction of North pole detected are supplied by the electronic compass driving circuit 72 to the CPU 39. Next, at step S32, the CPU 39 computes the difference D1x between the direction of North Pole and the direction of the X-axis with reference to the electronic camera 1: The result is stored in the buffer memory 36. At step S32, the CPU 39 computes the difference D1y between the direction of North Pole and the direction of the Y-axis with reference to the electronic camera 1. The result is stored in the buffer memory 36.

Next, at step S34, the CPU 39 determines whether or not the differences D0x and D0y between the direction of the North pole and the direction of the X-axis and the direction of the Y-axis, which were previously stored still exist. If the CPU 39 determines that the differences D0x and D0y, which were previously stored do not exist, the CPU 39 returns to step S31 and repeats the process at step S31 and beyond. If the CPU 39 determines that a difference between the D0x and D0y which were previously stored exists, the CPU 39 moves to step S35 and computes the differences DDx and DDy between the differences D0x and D0y which were stored previously and the differences D1x and D1y which are presently detected.

At step S36, the image displayed in the screen of the LCD 6 is scrolled by the number of pixels corresponding to the differences DDx and DDy in the direction corresponding to DDx and DDy.

Now suppose the shooting angle of the shooting lens 3 in the horizontal direction is q, the number of pixels of LCD 6 in the horizontal direction is 280 pixels, and the entire shooting range is displayed on the LCD 6. Moreover, if rotation of the electronic camera 1 by q/10 around Y-axis is detected from the change in bearing detected by the electronic compass, for example, the image displayed in LCD 6 may be moved vertically by 28 pixels, which is 1/10 of the number of pixels in the horizontal direction. Moreover, when the electronic camera 1 is rotated around the X-axis, the image being displayed in LCD 6 may move vertically in a manner similar to the case in which the electronic camera 1 is rotated around the Y-axis.

By doing this, the reproduced image may be scrolled giving the impression that the shooting screen is moved by swinging the electronic camera vertically and horizontally during reproduction (of a stored image) in a similar manner as the shooting screen is moved when the electronic camera 1 is swung vertically and horizontally while the user is monitoring the shooting screen through the LCD 6 during shooting. Of course, the user may be able to make the above setting a default setting and make the relationship between the amount of rotation of the electronic camera 1 and amount of scrolling of the screen being displayed in LCD 6 variable, which may be set by the user.

At step S37, the CPU 39 determines whether or not execution of another process is instructed by the user. If CPU 39 determines that execution of the other process is not instructed, the CPU 39 returns to step SI and repeats the process at step S1 and beyond. On the other hand, if the CPU 39 determines that execution of another process is selected by the user, CPU 39 moves to step S38, and executes and completes the other process.

In this manner, the rotation of the electronic camera 1 may be detected by the electronic compass 71, and the image being displayed in the screen of LCD 6 may be scrolled and the cursor being displayed in the screen of the LCD 6 may be moved corresponding to the rotation of the electronic camera 1 by the user.

The invention may be combined with the method for manipulating magnification rate of a reproduced image by means of a zooming member of a zoom lens, which was proposed by the applicant of the present application in Japanese LaidOpen Patent Publication 8-153783. By doing so, electronic zooming during reproduction is enabled with the same operation as zooming of the shooting lens 3 and the scrolling operation during reproduction may be executed under similar conditions as zooming during the shooting. Hence, ease-of-use may be improved.

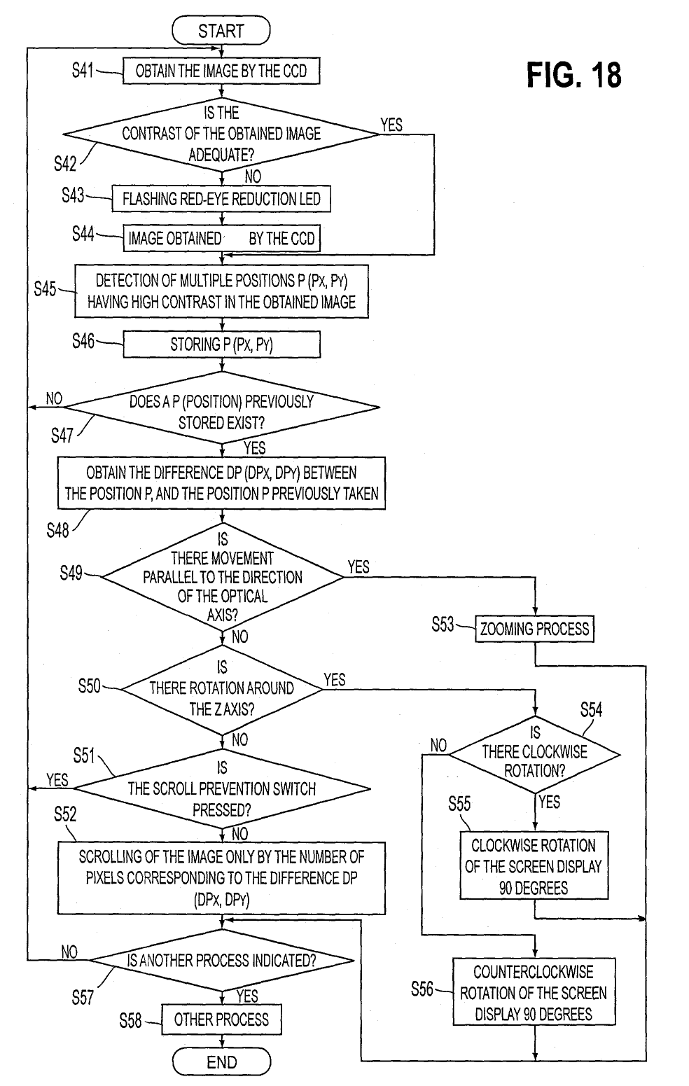

FIG. 18 shows the process steps for detecting the movement or rotation of the electronic camera, and for controlling the screen display, on the basis of an image obtained in a time series by a CCD 20 according to an embodiment of the invention.

In step S41, an image is obtained by the CCD 20 under the control of the CPU 39, which controls the image processor 31. The image signal is photoelectrically converted by the CCD 20 and is sampled under a specified timing. The sampled image signal is converted into digital image data in the A/D conversion circuit 32, and is supplied to the temporary buffer memory 36 by means of the DSP 33. The image data stored in the buffer memory by means of the DSP 33 is then read out, and following the execution of compression, is supplied to memory card 24 and stored. The process then goes to step S42.

In step S42, the CPU 39 determines whether the contrast of the image obtained in step S41 is adequate. In other words, a determination is made as to whether multiple components having a high contrast can be detected from within the obtained image. For example, if the background is completely dark, images having contrast cannot be obtained. If multiple components having high contrast can be detected in an image, the process moves to step S45.

If multiple components having a high contrast cannot be detected, the process moves on to step S43, and the CPU 39 controls the red eye reduction LED drive circuit 38 to flash the red eye reduction LED 15. The object on the surface X1 side of the electronic camera is thereby illuminated.

In step S44, in the same manner as accomplished above, an image can be obtained by means of the CCD 20 under the control of CPU 39. At this time, since there is a red eye reduction flash illuminating the object, there is contrast in the obtained image and multiple components having a high contrast can be detected. When obtaining the image by CCD 20 is completed, the CPU 39 controlling the red eye reduction drive circuit 38 turns off the red eye reduction LED. The process then moves to step S45.

In step S45, multiple components having high contrast are detected by means of CPU 39 from the images stored in memory card 24, by means of CPU 39. In step 46, the coordinate values Pᵢₙ (Pₓₙ, P_{yn}) on the display screen corresponding to the high contrast components are stored in buffer memory 36. In this instance, n corresponds to the multiple components having high contrast. The process then moves to step S47.

Next, in step S47, a determination is made as to whether or not the coordinate value Pₒₙ of high contrast components is stored. If there is no stored coordinate value Pₒₙ, then the process returns to step S41 and the processes after step S41 are re-executed. The cycle executed in steps S41-S47 can be 30 Hz for coordinating the cycles for obtaining the image. Furthermore, the red eye reduction LED 15 is intermittently flashed at cycles of 30 Hz.

In the absence of the red eye reduction LED 15, when the background is completely dark, illumination light can be provided by using illumination apparatus S which are not shown in the figures. Images, therefore, can still be obtained by the CCD 20.

When it is determined that the coordinate value Pₒₙ is stored, the process moves to step S48. The difference DPₙ (DPₓₙ, DP_{yn}) between the coordinate value Pₒₙ stored previously and the coordinate value Pᵢₙ currently detected can be obtained. The process then moves to step S49.

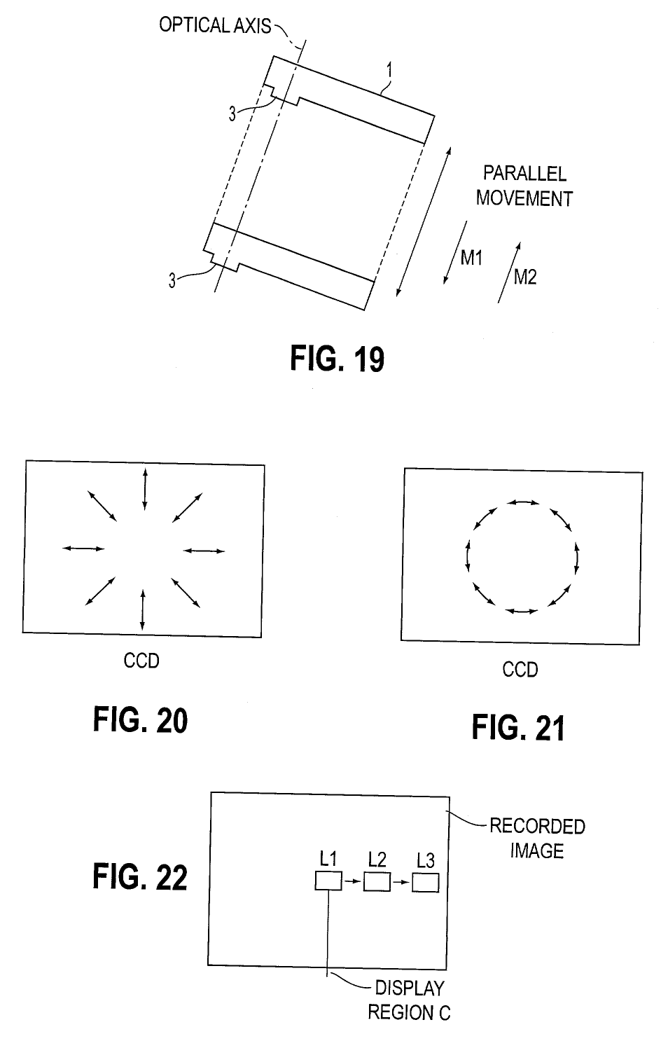

In step S49, CPU 39 determines whether the electronic camera has moved substantially parallel to the optical axis of the shooting lens 3, as shown in FIG. 19, on the basis of the difference DPₙ (DPₓₙ, DP_{yn}). This determination is accomplished on the basis of time series changes of multiple components having high contrast, as detected in step S45. For example, as shown in FIG. 20, where multiple components in the image have high contrast and move so that they are farther removed from the vicinity of the center of the image, or if they move closer to the center of the image, the electronic camera 1 is determined to have moved in a direction substantially parallel to the optical axis of the lens 3.

If the movement of electronic camera is determined to be in a direction substantially parallel to the optical axis, then the process proceeds to step S53 and a zooming process is accomplished under the control of CPU 39. For example, when the electronic camera moves in a direction parallel to the vector M1 shown in FIG. 19, the CPU 39 magnifies and displays the image within the display on the screen of LCD 6. On the other hand, when the electronic camera 1 moves in a direction parallel to the direction of the vector M2, shown in FIG. 19, the CPU 39 shrinks the displayed image on the screen of the LCD 6.

In step S49, if it is determined that the movement of the electronic camera 1 is not in a direction substantially parallel to the direction of the optical axis of the lens 3, the process moves to step S50. In step S50 a determination is made as to whether the electronic camera 1 has rotated around the Z axis, which passes through the center of the surface X2 from the center of the electronic camera 1 by a specified angle. This determination is made on the basis of time series changes of multiple components having a high contrast as detected in step S45. For example, as shown in FIG. 21, when multiple components having a high contrast move only so as to rotate around the vicinity of the center point of the image by a specified angle, it is determined that the electronic camera 1 has rotated around the Z axis by a specified angle.

If the electronic camera 1 is determined to have rotated around the Z axis by a specified angle, the process proceeds to step S54, and a determination is made as to whether the electronic camera 1 has rotated in a clockwise direction. If the electronic camera 1 has rotated in a clockwise direction, the process goes to step S55. In step S55, the image displayed on the screen of the LCD 6 is rotated, for example, in the clockwise direction by 90 degrees. If in step S54, if it is determined that the electronic camera 1 has not rotated in a clockwise direction, the process proceeds to step S56. In step S56, the image displayed on the screen of the LCD 6 is rotated in a counter clockwise direction, for example, by 90 degrees.

In addition, in step S50, where it is determined that the electronic camera 1 is not rotating around the Z axis, the process proceeds to step S51. In step S51, a determination is made as to whether the scroll prevention switch is pressed. In this instance, the scroll prevention switch may be a newly established specialized switch, and substitute use may be made of a release switch 10, or a sound recording switch 12. In the instance where the release switch 10 or the sound recording switch 12 are pressed during reproduction, the switches operate as scroll prevention switches. In step S51, if the scroll prevention switch is pressed utilizing CPU 39, the program returns to step S41 because scrolling of the image displayed on the screen of LCD 6 does not occur. The processes from step S41 on are repeated. On the other hand, when the scroll prevention switch is not pressed the program proceeds to step S52.

In step S52, the reproduction image displayed on the screen is scrolled for the specific number of pixels in the specified direction corresponding to the difference DPₙ (DPₓₙ, DP_{yn}). With regard to the detailed order of scrolling, reference is made to the flow chart shown in FIG. 11 because the process steps are identical, except that the explanation is abbreviated in FIG. 18.

Once the process steps S53, S55, S56, and S52 are completed, the program moves to step S57. In step S57, a determination is made as to whether another process is indicated. If no other process is indicated, the process returns to step S41, and the process begins again at step S41. On the other hand, if the case other processing is indicated, the process moves to step S58 and following the execution of other processes, the process is completed.

For example, referring to FIG. 22, if the display region C is assumed to be established in the position L1 within the recorded image, then if the image within the display region C is displayed on the screen of LCD 6 and if the electronic camera 1 is rotated in a specified direction around the Y axis, the display region C is caused to move within the recorded image. It then moves to position L2. As a result, the image within the display region C is displayed on the screen of the LCD 6 at position L2.

When the display region within the recorded image is caused to move and it is desired to display the image within the display region C at the position L3 on the screen of the LCD 6, there are instances in which it is difficult to further rotationally move the hand which holds the electronic camera 1 in the direction around the Y axis. In this instance, while temporarily pressing the scroll prevention switch, the electronic camera is rotated in the direction reverse to the direction around the Y axis. At this time, because the scroll prevention switch is pressed, the image within the display region C at the position L2 on the recorded image is continuously displayed on the screen of the LCD 6.

Next, pressing of the scroll prevention switch is stopped, and the electronic camera is rotated in a specified direction around the Y axis in order to move from the L2 position to the L3 position. The display region C thereby moves to the position L3 on the recorded image. The image within the display region C at position L3 is displayed on the screen of the LCD 6. In this manner, by using a scroll prevention switch, the operation of rotating the electronic camera 1 around the Y axis can be accomplished multiple times, by which the display region C can be moved to a selective position on the recorded image.

Therefore, the display region can be moved to a selective position on the recorded image, by repeating the rotational movement operation a specified number of times even in cases where the distance of movement of the display region C on the recorded image corresponding to the possible rotational movement of the electronic camera 1 in a single operation around the Y axis is small in comparison to the size of the recorded image.

The above description described instances in which the electronic camera 1 moved rotationally around the Y axis. However, when the electronic camera 1 moves rotationally around the X axis, the display region C can be moved vertically on the recorded image. In addition, rotation can be combined around the X axis and the Y axis. In this instance, the display region C can be moved in any selective direction on the recorded image.

In this manner, by using a scroll prevention switch, the electronic camera can be rotated around the X axis, the Y axis, or in a combined rotational movement which can be divided into multiple occurrences. In other words, the image displayed on the screen of the LCD 6 can be scrolled in any selective direction.

In addition, in the executed form, each process shown in the flow charts displayed in FIG. 11, FIG. 14, FIG. 17, and FIG. 18 which comprise programs accomplished by the CPU 39 can be stored in ROM 43 or the memory card 24 of the electronic camera 1. In addition, this program may also be supplied to users in the state in which it is pre-stored in ROM 43 or on a memory card 24, and may also be supplied to users in the state in which it is stored on ROM (compact disk—read only memory) so that it can be copied into ROM 43 or onto the memory card 24. In such a case, the ROM 43 can be, for example, with an electrically write capable EEPROM (electrically erasable and programmable read only memory). The program also can be supplied over a communications network such as the Internet (World Wide Web).

Here, in the above embodiment, an optical unit is used for the viewfinder 2 but a liquid crystal viewfinder may also be used.

In the above embodiment, the shooting lens, the viewfinder and the light emitting unit are arranged in this order from the left to right with the user facing the front of the electronic camera, but they may be arranged from the right to left. Only one microphone is provided but two microphones, one on the left and the other on the right, may be provided to record sound in stereo. Various information is input using a pen type pointing apparatus, but the information may be input using a finger.

The display screen which is displayed on LCD 6 is merely one example and does not limit the scope of the present invention. Screens with various layouts may be used as well. Likewise, operation key type and layout is one example and does not limit the scope of the present invention.

By pressing a scroll prevention switch, it is possible to prevent scrolling. Conversely, by attaching a scroll permit switch which permits scrolling only when the scroll permit switch is pressed results in an image displayed on the screen of the LCD 6 which can be scrolled in accordance with the rotational movement of the electronic camera 1. When the scroll permit switch is not pressed, even if the electronic camera is rotationally moved, it may not be possible to scroll the image. In this instance, the release switch 10 or the sound recording switch 12 can be substituted as a scroll permit switch.

Also, during the zooming process described earlier, and with reference to the flow chart shown in FIG. 18, a zooming prevention switch can be established which can prevent the zooming process or a zooming permit switch can be established which permits the zooming process. The same operation is made possible as described above with reference to the scroll prevention or scroll permit switch. In this instance, the release switch 10 or the sound recording switch 12 can be substituted for a zooming prevention switch or a zooming permit switch.

Moreover, in each of the embodiments above, cases for which the present invention is applied to an electronic camera is described, but it is also possible to apply the present invention to other portable equipment.

When movement or the rotational movement of the electronic camera 1 is detected on the basis of the obtained image, it is accomplished by means of time series like change of the contrast of the obtained image. However, it is also possible to detect the movement or rotation of the electronic camera 1 by means of the time series changes in the color of the obtained image. It is also possible to accomplish detection by means of another image process.

Moreover, it is also possible to have images and menu screens which are displayed in LCD 6 of the electronic camera 1 displayed in an external television set or a monitor by providing a terminal for outputting video signals.

While the invention has been described in conjunction with specific embodiments thereof, it is evident that many alternatives, modifications and variations will be apparent to those skilled in the art. Accordingly, the preferred embodiments of the invention set forth herein are intended to be illustrative, not limiting. Various changes may be made without departing from the spirit and scope of the invention as defined in the following claims.

What is claimed is:

1. An information processing apparatus comprising:
display means for displaying at least one of image information, character information and graphical information;
detection means for detecting at least one of rotation and linear movement of said display means; and
display changing means for changing a display content displayed by said display means according to at least one of rotation and linear movement of said display means as detected by said detection means.

2. The information processing apparatus according to claim 1, wherein said detection means also photographs an image and detects said at least one of rotation and linear movement of said display means based on a change in the photographed image over time.

3. The information processing apparatus according to claim 2, wherein said detection means includes a means for converting light to electric signals.

4. The information processing apparatus according to claim 1, wherein said detection means detects the rotation of said display means based upon detection of an angular velocity of said display means.

5. The information processing according to claim 4, wherein said detection means detects the angular velocity with respect to two axes.

6. The information processing apparatus according to claim 4, wherein said detection means includes a piezoelectric gyroscope.

7. The information processing apparatus according to claim 1, wherein said detection means detects the rotation of said display means based on a change in bearing information detected for the display means over time.

8. The information processing apparatus according to claim 7, wherein said detection means includes an electronic compass.

9. The information processing apparatus according to claim 1 further comprising:
photographic imaging means for generating a photographic image of a photographic object;
storage means for storing the photographic image generated by the photographic imaging means; and
control means for controlling imaging of the photographic object by the photographic imaging means and storage of the photographic image of the photographic object in the storage means;
wherein said display changing means changes the display content displayed by the display means when the control means generates a photographic image of a photographic object that is not stored in the storage means.

10. The information processing apparatus according to claim 2, wherein the display changing means changes a magnification amount of the contents displayed on the display means when the detection means detects movement of the display means in a direction along an optical axis of the detection means.

11. The information processing apparatus according to claim 1, further comprising prevention means for preventing the display changing means from changing the contents displayed on the display means when either the rotation or linear movement of the display means is detected by the detection means.

12. The information processing apparatus according to claim 11, wherein the display changing means rotates the display contents displayed on the display means by a specified angle when rotation around an axis perpendicular to a screen of the display means is detected by the detection means.

13. The information processing apparatus according to claim 1, wherein the display changing means scrolls the contents displayed on the display means in a specific direction when rotation around a specified axis parallel to a screen of the display means is detected by the detection means.

14. The information processing apparatus according to claim 1, wherein said apparatus is an electronic camera.

15. An information processing apparatus comprising:
a display that displays at least one of image information, character information and graphical information;
a detector that detects at least one of rotation and linear movement of said display; and
a display controller coupled to the display and to the detector to change a display content displayed by said display according to at least one of said rotation and said linear movement of said display as detected by said detector.

16. The information processing apparatus according to claim 15, wherein said detector is a photoelectric converter that photographs an image and detects at least one of the rotation and the linear movement of said display based on a change in the image over time.

17. The information processing apparatus according to claim 16, wherein the photoelectric converter includes a charge-coupled-device.

18. The information processing apparatus according to claim 16, wherein said detector detects the rotation by detecting the angular velocity of the display.

19. The information processing apparatus according to claim 18, wherein said detector detects the angular velocity with respect to two axes.

20. The information processing apparatus according to claim 15, wherein said detector includes a piezoelectric gyroscope.

21. The information processing apparatus according to claim 15, wherein said detector detects the rotation of said display based on a change in detected bearing information over time.

22. The information processing apparatus according to claim 15, wherein said detector includes an electronic compass.

23. The information processing apparatus according to claim 15, further comprising:
a photoelectric converter that generates a photographic image of a photographic object;
a memory that stores said photographic image generated by the photoelectric converter; and wherein:
the display controller is coupled to the photoelectric converter and to the memory to control imaging of the photographic object by the photoelectric converter and storage of the photographic image in the memory, said controller changes the display content based on photographic images that are not stored in the memory.

24. The information processing apparatus according to claim 23, further comprising a prevention device coupled to the display controller to prevent the display controller from changing the contents displayed on the display when either said at least one of rotation and linear movement is detected by the detector.

25. The information processing apparatus according to claim 15, wherein the display controller rotates the display content by a specified angle when rotation around an axis perpendicular to a screen of the display is detected by the detector.

26. The information processing apparatus according to claim 15, wherein the display controller changes the contents of the display by scrolling the display.

27. The information processing apparatus according to claim 15, wherein the display controller changes the contents of the display by changing a magnification of an image displayed on the display.

28. The information processing apparatus according to claim 15, wherein said apparatus is an electronic camera.

29. An information processing method, comprising the steps of:
displaying at least one of image information, character information and graphical information on a display;
detecting at least one of rotation and linear movement of an electronic device; and
changing the display content on the display according to the detected at least one of rotation and linear movement of said electronic device.

30. The method according to claim 29, wherein said detecting step includes photographing an image and detecting the at least one of rotation and linear movement based on a change in the photographed image over time.

31. The method according to claim 30, wherein the rotation is detected by detecting angular velocity.

32. The method according to claim 31, wherein the angular velocity is detected with respect to two axes.

33. The method according to claim 29, wherein the display content is changed by changing a magnification level of the contents displayed on the display.

34. The method according to claim 29, further comprising selectively preventing the display from changing the display contents upon receipt of a prohibit signal.

35. The method according to claim 29, wherein the display contents are changed by rotating the display contents displayed on the display by a specified angle when rotation around a specified axis is detected.

36. The method according to claim 29,wherein the display contents are changed by scrolling the contents displayed on the display in a specific direction.

37. The method according to claim 29,wherein the electronic device is the display.

38. The method according to claim 29,wherein the electronic device is a digital camera.

39. A recording medium that stores a computer-readable control program that is executable by a controller of an information processing apparatus to perform the steps of:
displaying at least one of image information, character information and graphical information on a display;
detecting at least one of rotation and linear movement of an electronic device; and
changing the display content according to the detected at least one of rotation and linear movement of said electronic device.

40. The recording medium according to claim 39, wherein said detecting step includes photographing an image and detecting the at least one of rotation and linear movement based on a change in the photographed image over time.

41. The recording medium according to claim 40, wherein the rotation is detected by detecting angular velocity.

42. The recording medium according to claim 41, wherein the angular velocity is detected with respect to two axes.

43. The recording medium according to claim 39, wherein the display content is changed by changing a magnification level of the contents displayed on the display.

44. The recording medium according to claim 39, further comprising selectively preventing the display from changing the display contents upon receipt of a prohibit signal.

45. The recording medium according to claim 39, wherein the display contents are changed by rotating the display contents displayed on the display by a specified angle when rotation around a specified axis is detected.

46. The recording medium according to claim 39,wherein the display contents are changed by scrolling the contents displayed on the display in a specific direction.

47. The recording medium according to claim 39,wherein the electronic device is the display.

48. The recording medium according to claim 39,wherein the electronic device is a digital camera.

49. An information processing apparatus comprising:
a display that displays at least one of image information, character information and graphical information;
a detector that detects at least one of rotation and linear movement of an electronic device; and
a display controller coupled to the display and to the detector to change a display content displayed by said display according to at least one of said rotation and said linear movement of said electronic device as detected by said detector.

50. The information processing apparatus of claim 49, wherein said electronic device is a digital camera.

51. The information processing apparatus of claim 49, wherein said electronic device is a device that stores said at least one of image information, character information and graphical information.
